(19) United States
(12) Patent Application Publication
(10) Pub. No.: US 2016/0366646 A1
(43) Pub. Date: Dec. 15, 2016

(54) OPERATION METHOD OF COMMUNICATION NODE IN AUTOMOTIVE NETWORK

(71) Applicant: Hyundai Motor Company, Seoul (KR)

(72) Inventors: Jin Hwa Yun, Seoul (KR); Kang Woon Seo, Seoul (KR); Dong Ok Kim, Goyang (KR)

(73) Assignee: Hyundai Motor Company, Seoul (KR)

(21) Appl. No.: 15/156,442

(22) Filed: May 17, 2016

(30) Foreign Application Priority Data
Jun. 11, 2015 (KR) 10-2015-0082610

(51) Int. Cl. H04W 52/02; G06F 9/44; H04L 29/08

(52) U.S. Cl. CPC H04W 52/0229; H04L 67/12; G06F 9/4406

(57) ABSTRACT

An operation method of a communication node including a physical (PHY) layer block and a controller , includes: receiving, at the PHY layer block, a signal transmitted from a counterpart communication node; transmitting, by the PHY layer block, a wakeup signal for waking up the controller to the controller; storing, by the PHY layer block, data included in the signal received from the counterpart communication node in a PHY layer buffer; and transmitting, by the PHY layer block, the data stored in the PHY layer buffer to the controller.

### CROSS-REFERENCE TO RELATED APPLICATIONS

This application claims priority to and the benefit of Korean Patent Application No. 10-2015-0082610 filed on Jun. 11, 2015 in the Korean Intellectual Property Office (KIPO), wherein the entire contents of which are hereby incorporated by reference.

### BACKGROUND

1. Technical Field

The present disclosure relates generally to communications between nodes in an automotive network, and more particularly, to a technique for preventing data loss in a receiving communication node when data communications are performed between communication nodes.

2. Related Art

Along with the rapid digitalization of vehicle parts, the number and variety of electronic devices installed within a vehicle have been increasing significantly. Electronic devices may currently be used in a power train control system, a body control system, a chassis control system, an automotive network, a multimedia system, and the like. The power train control system may include an engine control system, an automatic transmission control system, etc. The body control system may include a body electronic equipment control system, a convenience apparatus control system, a lamp control system, etc. The chassis control system may include a steering apparatus control system, a brake control system, a suspension control system, etc.

Meanwhile, an automotive network may include a controller area network (CAN), a FlexRay-based network, a media oriented system transport (MOST)-based network, etc. The multimedia system may include a navigation apparatus system, a telematics system, an infotainment system, etc.

Such systems and electronic devices constituting each of the systems are connected via the automotive network, which supports functions of the electronic devices. For instance, the CAN may support a transmission rate of up to 1 Mbps and may support auto retransmission of colliding messages, error detection-based on a cyclic redundancy check (CRC), etc. The FlexRay-based network may support a transmission rate of up to 10 Mbps and may support simultaneous transmission of data through two channels, synchronous data transmission, etc. The MOST-based network is a communication network for high-quality multimedia, which may support a transmission rate of up to 150 Mbps.

Meanwhile, the telematics system, the infotainment system, as well as enhanced safety systems of a vehicle require high transmission rates and system expandability. However, the CAN, FlexRay-based network, or the like may not sufficiently support such requirements. The MOST-based network may support a higher transmission rate than the CAN and the FlexRay-based network. However, costs increase to apply the MOST-based network to all automotive networks. Due to these limitations, an Ethernet based network may be considered as an automotive network. The Ethernet-based network may support bi-directional communication through one pair of windings and may support a transmission rate of up to 10 Gbps.

Each communication node constituting the automotive network may include a physical (PHY) layer block configured to perform data or control signal communications with external nodes and a controller configured to perform functions of the communication node. In order to reduce power consumption of the communication node, in some cases only the PHY layer block is activated, and the controller rapidly transitions from an inactivation mode to an activation mode according to a signal received from an external node. The controller may start performing an operating system (OS) booting operation when the PHY layer block receives the data or control signal from the external node. Therefore, the data having been received at the PHY layer block before the OS booting operation of the OS is completed may be lost since the data is received during an inactive mode of the controller.

### SUMMARY

Accordingly, embodiments of the present disclosure are provided to substantially obviate one or more problems due to limitations and disadvantages of the related art. Embodiments of the present disclosure provide operation methods of a communication node, in which a PHY layer of the communication node receiving data stores the received data temporarily until completion of a booting operation in a controller layer, and transfers the stored data to the controller layer after completion of the booting operation in the controller layer.

In accordance with embodiments of the present disclosure, an operation method of a communication node, which includes a physical (PHY) layer block and a controller, includes: receiving, at the PHY layer block, a signal transmitted from a counterpart communication node; transmitting, by the PHY layer block, a wakeup signal for waking up the controller to the controller; storing, by the PHY layer block, data included in the signal received from the counterpart communication node in a PHY layer buffer; and transmitting, by the PHY layer block, the data stored in the PHY layer buffer to the controller.

The PHY layer block may transmit the wakeup signal to the controller via at least one of: a media independent interface (MII), a reduced MII (RMII), a gigabit MII (GMII), a reduced GMII (RGMII), a serial GMII (SGMII), and a 10 GMII (XGMII).

The PHY layer block may perform the transmitting of the wakeup signal and the storing of the data in a parallel processing manner.

The transmitting of the data stored in the PHY layer buffer to the controller may include: receiving an operating system (OS) booting completion signal from the controller; and transmitting the data stored in the PHY layer buffer to the controller in response to the OS booting completion signal.

In the transmitting the data stored in the PHY layer buffer to the controller, the data stored in the PHY layer buffer may be transmitted to the controller after a lapse of a predetermined time from a point in time of transmitting the wakeup signal.

The method may further include cutting off power for driving the PHY layer buffer after the transmitting the of data stored in the PHY layer buffer to the controller.

The communication node may operate as connected to an automotive network.

Furthermore, in accordance with embodiments of the present disclosure, an operation method of a communication node, which includes a physical (PHY) layer block and a controller includes: receiving, at the controller, a wakeup signal for waking up the controller from the PHY layer block; performing, by the controller, a booting operation of an operating system (OS); and storing, by the controller, data received from the PHY layer block.

The wakeup signal may be received from the PHY layer block via at least one of a media independent interface (MII), a reduced MII (RMII), a gigabit MII (GMII), a reduced GMII (RGMII), a serial GMII (SGMII), and a 10 GMII (XGMII).

The method may further include transmitting an OS booting completion signal to the PHY layer block after completion of the booting operation, wherein the OS booting completion signal indicates the completion of the booting operation.

The communication node may be connected to an automotive network.

Furthermore, in accordance with embodiments of the present disclosure, a physical (PHY) layer block of a communication node, which includes the PHY layer block and a controller includes: a PHY layer interface part receiving a signal transmitted from a counterpart communication node; a PHY layer buffer storing data included in the received signal; and a PHY layer processor controlling the PHY layer interface part to transmit a wakeup signal for waking up the controller, and controlling the PHY layer buffer to store the data included in the received signal in the PHY layer buffer. Also, the PHY layer processor controls the PHY layer buffer to transmit the data stored in the PHY layer buffer to the controller.

The PHY layer interface part may transmit the wakeup signal to the controller via at least one of a media independent interface (MII), a reduced MII (RMII), a gigabit MII (GMII), a reduced GMII (RGMII), a serial GMII (SGMII), and a 10 GMII (XGMII).

The PHY layer processor may control the PHY layer interface part and the PHY layer buffer such that the transmitting of the wakeup signal and the storing of the data are performed in a parallel processing manner.

The PHY layer processor may control the PHY layer buffer to transfer the data stored in the PHY layer buffer to the controller after receiving an OS booting completion signal from the controller.

The PHY layer processor may control the PHY layer buffer to transfer the data stored in the PHY layer buffer to the controller after a lapse of a predetermined time from a point in time of the transmitting of the wakeup signal.

Here, the PHY layer processor may cut off power for driving the PHY layer buffer after transmitting the data stored in the PHY layer buffer to the controller.

Furthermore, in accordance with embodiments of the present disclosure, a controller of a communication node, which includes a physical (PHY) layer block and the controller includes: a controller interface part receiving a wakeup signal for waking up the controller from the PHY layer block; a core performing an operating system (OS) booting operation according to the wakeup signal; a memory control logic controlling a storage part to store at least one of data for the OS booting operation and data transmitted from the PHY layer block; and the storage part storing the at least one of data for the OS booting operation and data transmitted from the PHY layer block according to control of the memory control logic.

The controller interface part may receive the wakeup signal through at least one of: a media independent interface (MII), a reduced MII (RMII), a gigabit MII (GMII), a reduced GMII (RGMII), a serial GMII (SGMII), and a 10 GMII (XGMII).

The core may control the controller interface part to transmit an OS booting completion signal indicating completion of the OS booting operation to the PHY layer block when the OS booting operation is completed.

According to the embodiments of the present disclosure, when data communications are performed between communication nodes in automotive network, data loss can be prevented even when the data are received during a booting operation in a receiving communication node. That is, even when the data are received during the booting operation in a controller of the receiving communication node, data loss, which can occur during the booting operation of an operating system (OS), can be prevented by temporarily storing data being received in a PHY layer block of the receiving communication node and transferring the stored data to the controller after completion of the booting operation.

### BRIEF DESCRIPTION OF DRAWINGS

Embodiments of the present disclosure will become more apparent by describing in detail embodiments of the present disclosure with reference to the accompanying drawings, in which:

FIG. 1 is a diagram showing an automotive network topology according to embodiments of the present disclosure;

FIG. 2 is a diagram showing a communication node constituting an automotive network according to embodiments of the present disclosure;

FIG. 3 is a block diagram illustrating relations of communication nodes in a network;

FIG. 4 is a flow chart to explain a communication node operation method according to embodiments of the present disclosure;

FIG. 5 is a flow chart to explain a communication node operation method according to embodiments of the present disclosure;

FIG. 6 is a block diagram to explain a PHY layer block of a communication node according to embodiments of the present disclosure; and

FIG. 7 is a block diagram to explain a controller of a communication node according to embodiments of the present disclosure.

It should be understood that the above-referenced drawings are not necessarily to scale, presenting a somewhat simplified representation of various preferred features illustrative of the basic principles of the disclosure. The specific design features of the present disclosure, including, for example, specific dimensions, orientations, locations, and shapes, will be determined in part by the particular intended application and use environment.

### DETAILED DESCRIPTION OF THE EMBODIMENTS

Hereinafter, embodiments of the present disclosure will be described in detail with reference to the accompanying drawings. As those skilled in the art would realize, the described embodiments may be modified in various different ways, all without departing from the spirit or scope of the present disclosure. Further, throughout the specification, like reference numerals refer to like elements.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g., fuels derived from resources other than petroleum).

Additionally, it is understood that one or more of the below methods, or aspects thereof, may be executed by at least one controller. The term “controller” may refer to a hardware device that includes a memory and a processor. The memory is configured to store program instructions, and the processor is specifically programmed to execute the program instructions to perform one or more processes which are described further below. Moreover, it is understood that the below methods may be executed by an apparatus comprising the controller in conjunction with one or more other components, as would be appreciated by a person of ordinary skill in the art. Further, although embodiments are described as using a plurality of units to perform the exemplary process, it is understood that the exemplary processes may also be performed by one or plurality of modules.

Furthermore, control logic of the present disclosure may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

Since the present disclosure may be variously modified and have several embodiments, specific embodiments will be shown in the accompanying drawings and be described in detail in the detailed description. It should be understood, however, that it is not intended to limit the present disclosure to the specific embodiments but, on the contrary, the present disclosure is to cover all modifications and alternatives falling within the spirit and scope of the present disclosure.

Relational terms such as first, second, and the like may be used for describing various elements, but the elements should not be limited by the terms. These terms are only used to distinguish one element from another. For example, a first component may be named a second component without being departed from the scope of the present disclosure and the second component may also be similarly named the first component. The term ‘and/or’ means any one or a combination of a plurality of related and described items.

When it is mentioned that a certain component is “coupled with” or “connected with” another component, it should be understood that the certain component is directly “coupled with” or “connected with” to the other component or a further component may be located therebetween. In contrast, when it is mentioned that a certain component is “directly coupled with” or “directly connected with” another component, it will be understood that a further component is not located therebetween.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Unless otherwise defined, all terms (including technical and scientific terms) used herein have the same meaning as commonly understood by one of ordinary skill in the art to which this disclosure belongs. Terms such as terms that are generally used and have been in dictionaries should be construed as having meanings matched with contextual meanings in the art. In this description, unless defined clearly, terms are not ideally, excessively construed as formal meanings.

Hereinafter, embodiments of the present disclosure will be described in detail with reference to the accompanying drawings. In describing the disclosure, to facilitate the entire understanding of the disclosure, like numbers refer to like elements throughout the description of the figures and the repetitive description thereof will be omitted.

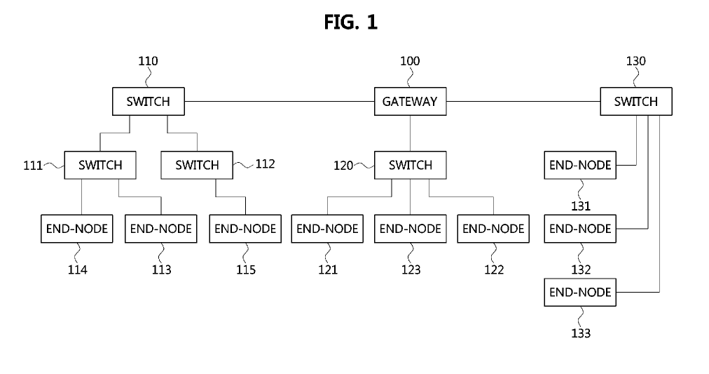

FIG. 1 is a diagram showing an automotive network topology according to embodiments of the present disclosure.

As shown in FIG. 1, a communication node may include a gateway, a switch (or bridge), or an end node. The gateway 100 may be connected with at least one switch 110, 111, 112, 120, and 130 and may be configured to connect different networks. For example, the gateway 100 may connect a switch that supports a controller area network (CAN) (e.g., FlexRay, media oriented system transport (MOST), or local interconnect network (LIN)) protocol and a switch that supports an Ethernet protocol. The switches 110, 111, 112, 120, and 130 may be connected with at least one end nodes 113, 114, 115, 121, 122, 123, 131, 132, and 133. The switches 110, 111, 112, 120, and 130 may interconnect and operate the end nodes 113, 114, 115, 121, 122, 123, 131, 132, and 133.

The end nodes 113, 114, 115, 121, 122, 123, 131, 132, and 133 may include an electronic control unit (ECU) configured to operate various types of devices mounted within a vehicle. For example, the end nodes 113, 114, 115, 121, 122, 123, 131, 132, and 133 may include an ECU configured to operate an infotainment device (e.g., a display device, a navigation device, and an around view monitoring device).

Communication nodes (e.g., a gateway, a switch, an end node, or the like) included in an automotive network may be connected in a star topology, bus topology, ring topology, tree topology, mesh topology, etc. In addition, the communication nodes of the automotive network may support a CAN protocol, FlexRay protocol, MOST protocol, LIN protocol, or Ethernet protocol. Embodiments of the present disclosure may be applied to the above-described network topology. The network topology to which exemplary embodiments of the present disclosure are to be applied is not limited thereto and may be configured in various ways.

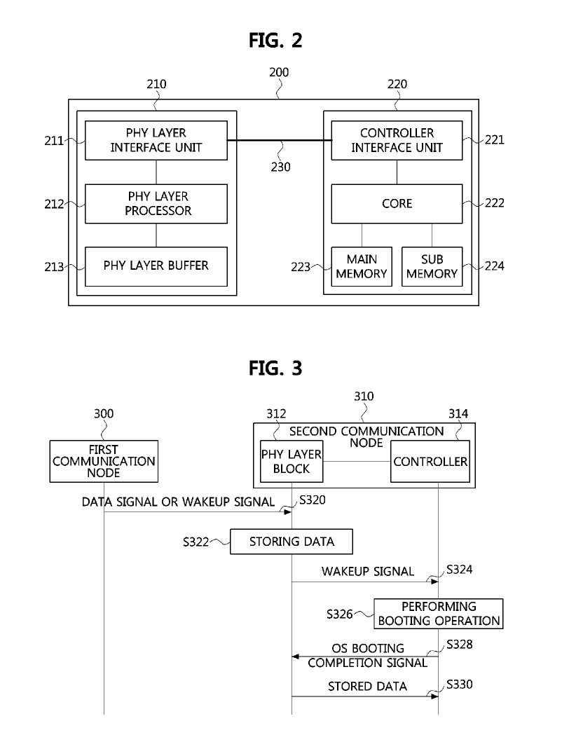

FIG. 2 is a diagram showing a communication node constituting an automotive network according to embodiments of the present disclosure. Notably, the various methods discussed herein below may be executed by a controller having a processor and a memory.

As shown in FIG. 2, a communication node 200 of a network may include a PHY layer block 210 and a controller 220. In particular, the controller 220 may be implemented to include a medium access control (MAC) layer. A PHY layer block 210 may be configured to receive or transmit signals from or to another communication node. The controller 220 may be configured to operate the PHY layer block 210 and perform various functions (e.g., an infotainment function). The PHY layer block 210 and the controller 220 may be implemented as one system on chip (SoC) or alternatively, may be implemented as separate chips.

Further, the PHY layer block 210 and the controller 220 may be connected via a media independent interface (MII) 230. The MII 230 may include an interface defined in the IEEE 802.3 and may include a data interface and a management interface between the PHY layer block 210 and the controller 220. One of a reduced MII (RMII), a gigabit MII (GMII), a reduced GMII (RGMII), a serial GMII (SGMII), a 10 GMII (XGMII) may be used instead of the MII 230. A data interface may include a transmission channel and a reception channel, each of which may have an independent clock, data, and a control signal. The management interface may include a two-signal interface, one signal for the clock and one signal for the data.

Particularly, the PHY layer block 210 may include a PHY layer interface part 211, a PHY layer processor 212, and a PHY layer buffer 213. The configuration of the PHY layer block 210 is not limited thereto, and the PHY layer block 210 may be configured in various ways. The PHY layer interface part 211 may be configured to transmit a signal received from the controller 220 to the PHY layer processor 212 and transmit a signal received from the PHY layer processor 212 to the controller 220. The PHY layer processor 212 may be configured to execute operations of the PHY layer interface part 211 and the PHY layer buffer 213. The PHY layer processor 212 may be configured to modulate a signal to be transmitted or demodulate a received signal. The PHY layer processor 212 may be configured to operate the PHY layer buffer 213 to input or output a signal. The PHY layer buffer 213 may be configured to store the received signal and output the stored signal based on a request from the PHY layer processor 212.

The controller 220 may be configured to monitor and operate the PHY layer block 210 using the MII 230. The controller 220 may include a controller interface part 221, a core 222, a main memory 223, and a sub memory 224. The configuration of the controller 220 is not limited thereto, and the controller 220 may be configured in various ways. The controller interface part 221 may be configured to receive a signal from the PHY layer block 210 (e.g., the PHY layer interface part 211) or an upper layer (not shown), transmit the received signal to the core 222, and transmit the signal received from the core 222 to the PHY layer block 210 or upper layer. The core 222 may further include an independent memory control logic or an integrated memory control logic for operating the controller interface 221, the main memory 223, and the sub memory 224. The memory control logic may be implemented to be included in the main memory 223 and the sub memory 224 or may be implemented to be included in the core 222.

Furthermore, each of the main memory 223 and the sub memory 224 may be configured to store a signal processed by the core 222 and may be configured to output the stored signal based on a request from the core 222. The main memory 223 may be a volatile memory (e.g., a random access memory (RAM)) configured to temporarily store data required for the operation of the core 222. The sub memory 224 may be a non-volatile memory in which operating system codes (e.g., kernel and device drivers) and an application program code for performing a function of the controller 220 may be stored. A flash memory having a high processing speed or a hard disc drive (HDD) or a compact disc-read only memory (CD-ROM) for large capacity data storage may be used as the non-volatile memory. Typically, the core 222 may include a logic circuit having at least one processing core. A core of an Advanced RISC Machines (ARM) family or a core of an Atom family may be used as the core 222.

A method performed by a communication node and a corresponding counterpart communication node, which belong to an automotive network, will be described below. Although a method (e.g., signal transmission or reception) performed by a first communication node will be described below, a second communication node that corresponds thereto may perform a method (e.g., signal reception or transmission) corresponding to the method performed by the first communication node. In other words, when an operation of the first communication node is described, the second communication node corresponding thereto may be configured to perform an operation that corresponds to the operation of the first communication node. Additionally, when an operation of the second communication node is described, the first communication node may be configured to perform an operation that corresponds to an operation of a switch.

FIG. 3 is a block diagram illustrating relations of communication nodes in a network.

As shown in FIG. 3, a first communication node 300 and a second communication node 310 are connected through a network. For example, the first communication 300 and the second communication node 310 may communicate using a CAN protocol, a FlexRay protocol, a MOST protocol, a LIN protocol, or an Ethernet protocol. Each of the first communication node 300 and the second communication node 310 may include a PHY layer block 312 and a controller 314. Here, the PHY layer block 312 and the controller 314 may be identical to the PHY layer block 210 and the controller 220 explained referring to FIG. 2.

The first communication node 300 having data to transmit to the second communication node 310 may generate a signal including the data (hereinafter, referred to as a ‘data signal’) or a signal for triggering wake-up of the second communication node 310 (hereinafter, referred to as a ‘wakeup signal’). When a channel is idle, the first communication mode 300 may transmit the data signal or the wakeup signal to the second communication node 310 (S320). When the wakeup signal is transmitted to the second communication node 310, the first communication node 300 may transmit the data to the second communication node 310 after a lapse of a predetermined time from a completion time of the wakeup signal transmission.

The PHY layer block 312 of the second communication 310 may perform an energy detection operation to determine whether a signal exists in a channel or not. The PHY layer block 312 may demodulate a received signal which is modulated in a predetermined modulation manner, and store the demodulated signal in the memory (S322).

The PHY layer block 312 may generate a wakeup signal for triggering wake-up of the controller 314 of the second communication node 310, and transmit the generated wake-up signal to the controller 314 (S324). The wakeup signal may be stored in a PHY layer buffer.

In response to the wakeup signal, the controller 314 may perform a booting operation of an operating system (OS) according to a predetermined booting sequence (S326).

When the booting operation of the OS is completed, an OS booting completion signal may be generated, and the generated OS booting completion signal may be transmitted to the PHY layer block 312 (S328). If the PHY layer block 312 does not receive the OS booting completion signal from the controller 314 within a predetermined time range, the PHY layer block 312 may transmit the wakeup signal to the controller 314 repeatedly. Upon receiving the OS booting completion signal from the controller 314, the PHY layer block 312 may determine that the booting operation of the OS in the controller 314 is completed. Also, the PHY layer block 312 may determine that the booting operation of the OS in the controller 314 is completed after a lapse of a predetermined time from a point in time of the wakeup signal transmission.

Hereinafter, respective aspects of the PHY layer block and the controller for a communication node operation method according to the present disclosure will be explained.

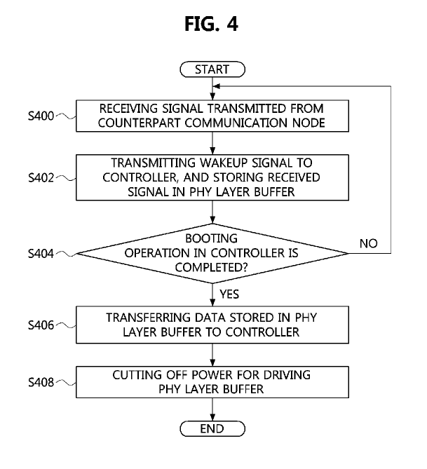

FIG. 4 is a flow chart to explain a communication node operation method according to embodiments of the present disclosure.

A PHY layer block constituting a communication node may receive a signal transmitted by a counterpart communication node (S400). As illustrated in FIG. 3, the PHY layer block 312 of the second communication node 310 may receive a signal transmitted by the first communication node 300 corresponding to a counterpart communication node. Here, the signal may be a signal including data or a wakeup signal.

The PHY layer block 312 may be always in an awake mode (i.e., active mode). The controller 314 basically may operate in a doze mode (i.e., inactive mode), and transition from doze mode to awake mode if necessary. The PHY layer block 312 may identify whether a signal exists in a channel or not through an energy detection operation. For example, the PHY layer block 312 may determine that there exists a signal in the channel when a signal having a strength greater than a predetermined threshold is detected through the energy detection operation.

Then, according to the signal reception, the PHY layer block 312 may transmit a wakeup signal for waking up the controller 314 to the controller 314, and store data included in the received signal in a PHY layer buffer (S402). As illustrated in FIG. 3, the PHY layer block 312 of the second communication node 310 may generate a wakeup signal for the controller 314 constituting the second communication node 310, and transmit the wakeup signal to the controller 314. Since the wakeup signal is a signal just for waking up the controller 314, it is not necessary that the controller 314 stores the received wakeup signal.

In this instance, the PHY layer block 312 may transmit the wakeup signal to the controller 314 via a predetermined interface. For this, the predetermined interface may exist between the PHY layer block 312 and the controller 314. Here, the predetermined interface may include a media independent interface (MII), a reduce MII (RMII), a gigabit MII (GMII), a reduce GMII (RGMII), a serial GMII (SGMII), or a 10 GMII (XGMII).

Meanwhile, if the PHY layer block 312 receives a signal from the counterpart communication node, the PHY layer block 312 may store data included in the received signal in its PHY layer buffer. Here, the PHY layer buffer may be a memory space for storing data received from the counterpart communication node before completion of the booting operation of the OS in the controller 314.

The PHY layer 312 may demodulate the received signal which has been modulated in a predetermined modulation manner. The PHY layer block 312 may transfer the demodulated signal to the PHY layer buffer, and the PHY layer buffer may store the demodulated signal in a buffer memory of the PHY layer buffer.

The PHY layer block 312 may perform the procedure of transmitting the wakeup signal to the controller 314 and the procedure of storing the received data in the PHY layer buffer in a parallel processing manner. That is, the PHY layer block 312 may simultaneously perform the wakeup signal transmission and the received data storing.

After the step S402, the PHY layer block 312 may determine whether the OS booting operation in the controller 314 is completed (S404). The determination may be performed according to an OS booting completion signal from the controller 314. For example, the controller 314 may perform the booting operation according to the wakeup signal, and transmit the OS booting completion signal to the PHY layer block 312 when the booting operation is completed.

Also, the OS booting operation may be performed according to a predetermined booting sequence. For example, the OS booting operation may be started from a booting strap executed according to activation of the controller 314. The controller 314 may load codes such as an OS kernel, device drivers, etc. stored in a sub memory into a main memory, and perform operations such as device initializations by using the OS kernel and device drivers. Here, an OS for automotive electronic equipment may be used as the OS. Thus, a lightweight and small OS may be used. Also, according to a purpose of the electronic equipment for which the OS is used, a real-time OS or a non-real-time OS may be selectively used. For example, the OS may be an Android based OS, or a Windows based OS, etc. Accordingly, when the OS booting completion signal is received from the controller 314, the PHY layer block 312 may determine that the booting operation in the controller 314 has been completed.

Also, after a lapse of a predetermined time from the point in time of the wakeup signal transmission, without using the OS booting completion signal, the PHY layer block 312 may determine that the booting operation in the controller 314 has been completed. The predetermined time may be configured as a time enough for the booting operation in the controller 314 to be completed. The predetermined time may be set according to system configuration.

Meanwhile, if the booting operation in the controller 314 is not completed, the above-described step S400 and S402 may be performed repeatedly.

If it is determined that the booting operation in the controller 314 has been completed in the step S404, the PHY layer block 312 may transmit data stored in the PHY layer buffer to the controller 314 (S406). Since the booting operation of the controller 314 has been completed, the controller 314 can be in a state in which it can perform necessary operations by using the data transmitted from the counterpart communication node. Therefore, the data stored in the PHY layer buffer of the PHY layer block 312 may be transferred to the controller 314 such that the controller 314 can use the data. Accordingly, the controller 314 may store the data transferred from the PHY layer block 312 in the main memory of the controller 314, and execute an operation by using the stored data.

After the step S406, once the data stored in the PHY layer buffer have been transferred to the controller 314, the PHY layer block 312 may cut off a power for driving the PHY layer buffer (S408). If the data stored in the PHY layer buffer are transferred to the controller 314, the function of the PHY layer buffer may become unnecessary. Thus, for power saving, the PHY layer block 312 may cut off the power for the PHY layer buffer. In this instance, if the PHY layer buffer has a separate power supply unit (not depicted), the PHY layer block 312 may control the power supply unit to cut off the power for driving the PHY layer buffer.

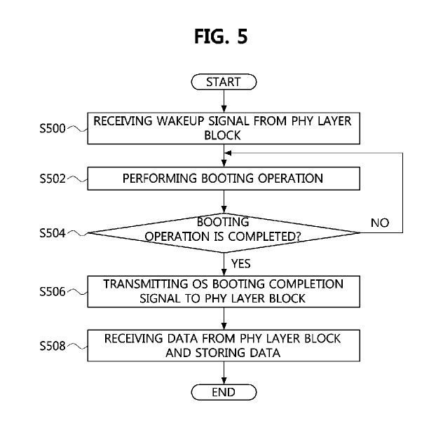

FIG. 5 is a flow chart to explain an additional/alternative communication node operation method according to embodiments of the present disclosure.

The controller constituting the communication node may receive the wakeup signal for waking up the controller from the PHY layer block (S500). As illustrated in FIG. 3, the controller 314 of the second communication node 310 may receive the wakeup signal for waking up the controller 314 from the PHY layer block 312 constituting the second communication node 310.

The controller 314 may receive the wakeup signal via a predetermined interface. For this, the predetermined interface may exist between the PHY layer block 312 and the controller 314. Here, as described above, the predetermined interface may include MII, RMII, GMII, RGMII, SGMII, or XGMII.

After the step S500, according to the wakeup signal reception, the controller 314 may start an OS booting operation (S502). That is, in response to the wakeup signal, the controller 314 may load data for the OS booting stored in a sub memory into a main memory, and start the booting operation.

After the step S502, the controller 314 may determine whether the OS booting is completed (S504). While the OS booting is not completed, the above-described step S502 may be continued.

If the OS booting is completed, the controller 314 may transmit an OS booting completion signal indicating completion of the OS booting operation to the PHY layer block 312 (S506). The OS booting completion signal may be a signal used for the controller 314 to notify the PHY layer block 312 of the completion of the OS booting operation. Upon receiving the OS booting completion signal, the PHY layer block 312 may identify that the booting operation in the controller 314 has been completed. However, the step S506 is not an essential step for the present disclosure. That is, if the PHY layer block 312 can determine whether the booting operation is completed by itself, it may be unnecessary that the controller 314 transmits the OS booting completion signal to the PHY layer block 312. For example, if the PHY layer block 312 can implicitly determine that the OS booting operation has been completed after a lapse of a predetermined time from the wakeup signal transmission, the OS booting completion signal may not be transmitted to the PHY layer block.

After the step S506, according to the completion of the booting operation, the controller 314 may receive and store data transmitted from the PHY layer block 312 (S508). If the booting operation is completed, the PHY layer block 312 may transmit the data temporarily stored in the PHY layer buffer to the controller 314. Accordingly, the controller 314 may receive the data from the PHY layer block 312, and store the data in the main memory. After then, the controller 314 may perform operations by using the data stored in the main memory.

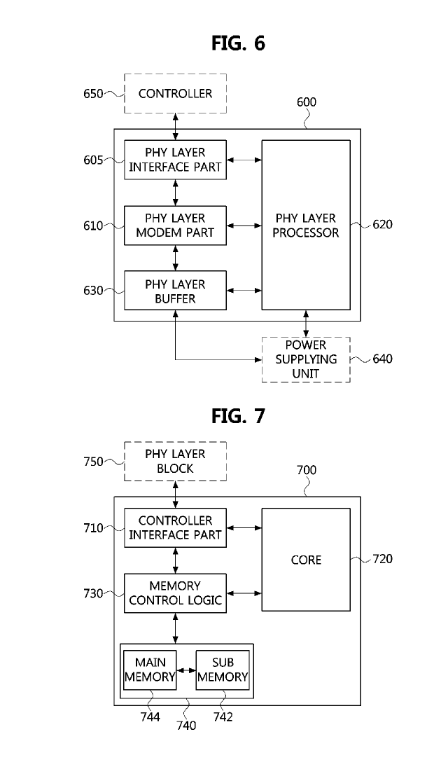

FIG. 6 is a block diagram to explain a PHY layer block of a communication node according to embodiments of the present disclosure.

As shown in FIG. 6, a PHY layer block 600 may include a PHY layer interface part 605, a PHY layer modulation/demodulation (hereinafter, “modem”) part 610, a PHY layer processor 620, a PHY layer buffer 630, and a power supply unit 640.

The PHY layer interface part 605 may receive a signal from a counterpart communication node. The signal which the PHY layer interface part 605 receives from the counterpart communication node may include a wakeup signal or data.

The PHY layer interface part 605 may be connected with the counterpart communication node via a predetermined interface to receive the signal from the counterpart communication node. Here, the predetermined interface may include a CAN network, a FlexRay network, a MOST network, a LIN network, or an Ethernet network. Such the network may be connected in forms of a star topology, a bus topology, a ring topology, a tree topology, a mesh topology, etc. Thus, the PHY layer interface part 605 may, for communications with the counterpart communication node, support a CAN protocol, a FlexRay protocol, a MOST protocol, a LIN protocol, or an Ethernet protocol.

The PHY layer interface part 605 may identify whether there exist a signal in a channel through an energy detection operation. That is, the PHY layer interface part 605 may determine that there exists the signal in the channel when the signal having a strength greater than a predetermined threshold through the energy detection operation.

The PHY layer interface part 605 may transmit the received signal to the PHY layer modem part 610, and notify the PHY layer processor 620 that the signal exists in the channel Alternatively, the PHY layer interface part 605 may transmit the received signal to the PHY layer processor 620, and the PHY layer processor 620 may determine that there exists the signal in the channel based on the signal received from the PHY layer interface part 605, and transfer the signal received from the PHY layer interface part 605 to the PHY layer modem part 610.

Also, the PHY layer interface part 605 may transmit a wakeup signal for waking up the controller 650 to the controller 650. Here, the PHY layer interface part 605 may transmit the wakeup signal to the controller 650 via a predetermined interface. Here, the predetermined interface may include MII, RMII, GMII, RGMII, SGMII, or XGMII.

Upon receiving the signal from the controller 650, the PHY layer modem part 610 may perform modulation on the received signal, and transfer the modulated signal to at least one of the PHY layer interface part 605, the PHY layer processor 620, and the PHY layer buffer 630.

Also, when the PHY layer modem part 610 receives the signal from the PHY layer interface part 605 or the PHY layer processor 620, the PHY layer modem part 610 may obtain data included in the received signal by performing demodulation on the received signal, and transfer the obtained data to the PHY layer processor 620 or the PHY layer buffer 630.

The PHY layer processor 620 may control respective operations of the PHY layer interface part 605, the PHY layer modem part 610, and the PHY layer buffer 630. The PHY layer processor 620 may generate or extract the wakeup signal for waking up the controller 650 based on the received signal, and control the PHY layer interface part 605 to transmit the wakeup signal to the controller 650. Accordingly, the PHY layer interface part 605 may transmit the wakeup signal to the controller 650 via the predetermined interface.

Also, the PHY layer processor 620 may control the PHY layer buffer 630 to store the data included in the received signal. For this, when the PHY layer processor 620 receives the signal from the counterpart communication node, the PHY layer processor 620 may control the PHY layer modem part 610 to demodulate the received signal, thereby obtaining the data included in the received signal. Accordingly, the PHY layer processor 620 may transfer the data demodulated in the PHY layer model part 610 to the PHY layer buffer 630.

The PHY layer processor 620 may control the other parts to perform the transmission of the wakeup signal and the received data storing in a parallel processing manner. That is, the PHY layer processor 620 may simultaneously perform the wakeup signal transmission and the received data storing.

The PHY layer buffer 630 may store the received data according to control of the PHY layer processor 620. The PHY layer buffer 630 may store the received data temporarily until completion of the booting operation in the controller 650. The PHY layer buffer 630 may store the demodulated data according to control of the PHY layer processor 620. Also, the PHY layer buffer 630 may output the stored data according to request of the PHY layer processor 620.

Then, the controller 650 may perform the booting operation according to the wakeup signal, and transmit the OS booting completion signal to the PHY layer block when the booting operation is completed. Accordingly, upon receiving the booting completion signal from the controller 650, the PHY layer processor 620 may determine that the booting operation in the controller 650 has been completed. Therefore, after receiving the booting completion signal from the controller 650, the PHY layer processor 620 may control the PHY layer interface part 605 to transmit the data stored in the PHY layer buffer 630 to the controller 650.

Also, even without the OS booting completion signal from the controller 650, the PHY layer processor 620 may determine that the booting operation in the controller 650 has been completed after a predetermined time is lapsed from the transmission of the wakeup signal. Here, the predetermined time may be a time enough for the controller 650 to complete the booting operation. Accordingly, the PHY layer processor 620 may control the PHY layer interface part 605 to transmit the data stored in the PHY layer buffer 630 to the controller 650, after a lapse of the predetermined time from the wakeup signal transmission to the controller 650.

When it is determined that the booting operation in the controller 650 has been completed, the PHY layer interface part 605 may transmit the data stored in the PHY layer buffer 630 to the controller 650 according to control of the PHY layer processor 620. Accordingly, the controller 650 may store the data transferred from the PHY layer block 600 in the main memory of the controller 650, and execute operations by using the stored data.

Meanwhile, after the data stored in the PHY layer buffer 630 are transferred to the controller 650, the PHY layer processor 620 may cut off a power for driving the PHY layer buffer 630. If the data stored in the PHY layer buffer 630 is transferred to the controller 650, the function of the PHY layer buffer 630 may become unnecessary. Thus, for power saving, the PHY layer processor 620 may cut off the power for the PHY layer buffer 630. In this instance, if a separate power supply unit 640 for controlling power supply to the PHY layer buffer 630 exists, the PHY layer processor 620 may control the power supply unit 640 to cut off the power supplied to the PHY layer buffer 630. Accordingly, the power supply unit 640 may cut off the power provided to the PHY layer buffer 630 for the booting operation of the controller 650. Meanwhile, the power supply unit 640 may provide respective powers to other components of the PHY layer block 600. Therefore, after the data stored in the PHY layer buffer 630 are transferred to the controller, the PHY layer processor 620 may cut off the powers provided to the other components.

FIG. 7 is a block diagram to explain a controller of a communication node according to embodiments of the present disclosure.

As shown in FIG. 7, a controller 700 may include a controller interface part 710, a core 720, a memory control logic 730, and a storing part 740.

The controller interface part 710 may receive the wakeup signal from the PHY layer block 750. The controller interface part 710 may receive the wakeup signal from the PHY layer block 750 via a predetermined interface. Here, the predetermined interface may include MII, RMII, GMII, RGMII, SGMII, or XGMII.

The core 720 may perform a booting operation of an OS according to the wakeup signal. Upon receiving the wakeup signal, the core 720 may control the memory control logic 730 to load a kernel of the OS and device drivers stored in a sub memory 742 of the storing part 740 into a main memory 724 of the storing part 740, thereby performing the booting operation.

Then, the core 720 may determine whether the OS booting operation has been completed. If the booting operation is completed, the core 720 may generate an OS booting completion signal indicating completion of the booting operation, and control the controller interface part 710 to transmit the generated OS booting completion signal to the PHY layer block 750. Accordingly, the controller interface part 710 may transmit the OS booting completion signal to the PHY layer block 750.

Upon receiving the OS booting completion signal from the controller 700, the PHY layer block 750 may identify that the booting operation in the controller 700 has been completed. Then, the PHY layer block 750 may transmit data temporarily stored in the PHY layer buffer to the controller 700.

When the controller interface part 710 receives the data transmitted from the PHY layer block 750, the core 720 may control the memory control logic 730 to store the received data.

The memory control logic 730 may control the storing part 740 to store the data processed by the core 720, and control the storing part 740 to output the stored data according to request of the core 720. Especially, the memory control logic 730 may control the storing part 740 to store at least one of data for the OS booting operation and data transmitted from the PHY layer block 750 after completion of the booting operation.

The storing part 740 may include the sub memory 742 and the main memory 744. The sub memory 742 may include a non-volatile memory storing OS codes (kernel and device drivers) and application program codes for functions of the controller. Here, the non-volatile memory may be usually a flash memory having fast processing speeds. However, any kinds of magnetic or optical medium such as HDD, CD-ROM, etc. having a large capacity may be used as the non-volatile memory. The main memory 744 may be usually a RAM which is a volatile memory for temporarily storing data needed for operations of the core 720. The main memory 744 is controlled by the memory control logic 730 to store the received data, thereby storing the received data. After then, the core 720 may execute operations by using the data stored in the main memory 744.

The methods according to embodiments of the present disclosure may be implemented as program instructions executable by a variety of computers and recorded on a computer readable medium. The computer readable medium may include a program instruction, a data file, a data structure, or a combination thereof. The program instructions recorded on the computer readable medium may be designed and configured specifically for the present disclosure or can be publicly known and available to those who are skilled in the field of computer software.

Examples of the computer readable medium may include a hardware device such as ROM, RAM, and flash memory, which are specifically configured to store and execute the program instructions. Examples of the program instructions include machine codes made by, for example, a compiler, as well as high-level language codes executable by a computer, using an interpreter. The above exemplary hardware device can be configured to operate as at least one software module in order to perform the operation of the present disclosure, and vice versa.

While the embodiments of the present disclosure and their advantages have been described in detail, it should be understood that various changes, substitutions and alterations may be made herein without departing from the scope of the disclosure.

What is claimed is:

1. An operation method of a communication node including a physical (PHY) layer block and a controller, the method comprising:
receiving, at the PHY layer block, a signal transmitted from a counterpart communication node;
transmitting, by the PHY layer block, a wakeup signal for waking up the controller to the controller;
storing, by the PHY layer block, data included in the signal received from the counterpart communication node in a PHY layer buffer; and
transmitting, by the PHY layer block, the data stored in the PHY layer buffer to the controller.

2. The method according to claim 1, further comprising transmitting, by the PHY layer block, the wakeup signal to the controller via at least one of: a media independent interface (MII), a reduced MII (RMII), a gigabit MII (GMII), a reduced GMII (RGMII), a serial GMII (SGMII), and a 10 GMII (XGMII).

3. The method according to claim 1, wherein the transmitting of the wakeup signal and the storing of the data are performed by the PHY layer block in a parallel processing manner.

4. The method according to claim 1, wherein the transmitting of the data stored in the PHY layer buffer to the controller comprises:
receiving an operating system (OS) booting completion signal from the controller; and
transmitting the data stored in the PHY layer buffer to the controller in response to the OS booting completion signal.

5. The method according to claim 1, wherein the transmitting of the data stored in the PHY layer buffer to the controller comprises:
transmitting the data stored in the PHY layer buffer to the controller after a lapse of a predetermined time from a point in time of transmitting the wakeup signal.

6. The method according to claim 1, further comprising cutting off power for driving the PHY layer buffer after the transmitting of the data stored in the PHY layer buffer to the controller.

7. The method according to claim 1, wherein the communication node is connected to an automotive network.

8. An operation method of a communication node including a physical (PHY) layer block and a controller, the method comprising:
receiving, at the controller, a wakeup signal for waking up the controller from the PHY layer block;
performing, by the controller, a booting operation of an operating system (OS); and
storing, by the controller, data received from the PHY layer block.

9. The method according to claim 8, receiving, at the controller, the wakeup signal from the PHY layer block via at least one of: a media independent interface (MII), a reduced MII (RMII), a gigabit MII (GMII), a reduced GMII (RGMII), a serial GMII (SGMII), and a 10 GMII (XGMII).

10. The method according to claim 8, further comprising transmitting an OS booting completion signal to the PHY layer block after completion of the booting operation, wherein the OS booting completion signal indicates the completion of the booting operation.

11. The method according to claim 8, wherein the communication node is connected to an automotive network.

12. A physical (PHY) layer block of a communication node including the PHY layer block and a controller, comprising:
a PHY layer interface part receiving a signal transmitted from a counterpart communication node;
a PHY layer buffer storing data included in the received signal; and
a PHY layer processor controlling the PHY layer interface part to transmit a wakeup signal for waking up the controller and controlling the PHY layer buffer to store the data included in the received signal in the PHY layer buffer,
wherein the PHY layer processor controls the PHY layer buffer to transmit the data stored in the PHY layer buffer to the controller.

13. The PHY layer block according to claim 12, wherein the PHY layer interface part transmits the wakeup signal to the controller via at least one of: a media independent interface (MII), a reduced MII (RMII), a gigabit MII (GMII), a reduced GMII (RGMII), a serial GMII (SGMII), and a 10 GMII (XGMII).

14. The PHY layer block according to claim 12, wherein the PHY layer processor controls the PHY layer interface part and the PHY layer buffer such that the transmitting of the wakeup signal and the storing of the data are performed in a parallel processing manner.

15. The PHY layer block according to claim 12, wherein the PHY layer processor controls the PHY layer buffer to transfer the data stored in the PHY layer buffer to the controller after receiving an OS booting completion signal from the controller.

16. The PHY layer block according to claim 12, wherein the PHY layer processor controls the PHY layer buffer to transfer the data stored in the PHY layer buffer to the controller after a lapse of a predetermined time from a point in time of the transmitting of the wakeup signal.

17. The PHY layer block according to claim 12, wherein the PHY layer processor cuts off power for driving the PHY layer buffer after transmitting the data stored in the PHY layer buffer to the controller.

18. A controller of a communication node including a physical (PHY) layer block and the controller, comprising:
a controller interface part receiving a wakeup signal for waking up the controller from the PHY layer block;
a core performing an operating system (OS) booting operation according to the wakeup signal;
a memory control logic controlling a storage part to store at least one of data for the OS booting operation and data transmitted from the PHY layer block; and
the storage part storing the at least one of data for the OS booting operation and data transmitted from the PHY layer block according to control of the memory control logic.

19. The controller according to claim 18, wherein the controller interface part receives the wakeup signal through at least one of: a media independent interface (MII), a reduced MII (RMII), a gigabit MII (GMII), a reduced GMII (RGMII), a serial GMII (SGMII), and a 10 GMII (XGMII).

20. The controller according to claim 18, wherein the core controls the controller interface part to transmit an OS booting completion signal indicating completion of the OS booting operation to the PHY layer block when the OS booting operation is completed.
